(19) United States
(12) Patent Application Publication
(10) Pub. No.: US 2006/0253726 A1
(43) Pub. Date: Nov. 9, 2006

(54) Fault-tolerant architecture for a distributed control system

(76) Inventors: Vikas Kukshya, Calabasas, CA (US); Hui-Pin Hsu, Northridge, CA (US); Timothy J. Talty, Beverly Hills, MI (US)

Correspondence Address: KATHRYN A MARRA;General Motors Corporation, Legal Staff, Mail Code 482-C23-B21, P.O. Box 300, Detroit, MI, 48265-3000, US

(21) Appl. No.: 11/335,001

(22) Filed: Jan. 19, 2006

Related U.S. Application Data
(60) Provisional application No. 60/678,424, filed on May 6, 2005.

(51) Int. Cl. G06F 11/00

(52) U.S. Cl. 714/4

(57) ABSTRACT

A fault-tolerant architecture, comprising fault tolerant units, a wire-based communication bus, and respective radio transceivers is offered. The fault-tolerant units communicate using the radio transceivers when communication via the wire-based communication bus is compromised by a fault. The intent is to enhance reliability and fault-tolerance of a distributed system architecture, such as a steer-by-wire system for a vehicle. The novel drive-by-wire/wireless architecture uses multiple wireless sensors and short-range low power radio transceivers associated with various micro-controllers. These sensors and radio transceivers allow the micro-controllers to communicate critical control signals and drive commands in the event of a communications fault, e.g. in a vehicle drive-by-wire system.

### CROSS-REFERENCE TO RELATED APPLICATIONS

This application claims priority from U.S. Provisional Application No. 60/678,424, filed May 6, 2005, entitled WIRELESS ARCHITECTURE FOR DRIVE-BY-WIRE SYSTEMS.

### TECHNICAL FIELD

This invention pertains generally to a distributed control system, and more specifically to a fault-tolerant control system useable in drive-by-wire systems for vehicles.

### BACKGROUND OF THE INVENTION

Engineers are developing control systems for next-generation vehicles which employ electronic modules and electromechanical devices which replace mechanical systems, to reduce vehicle mass and improve responsiveness and controllability. Such electronic modules and electromechanical devices are typically executed in distributed system architectures. By way of example, a steer-by-wire system employs electric steering motors which are able to replace mechanical steering components including power steering pumps, hoses, hydraulic fluids, drive belts, and brake servos. Such drive-by-wire architecture assists in vehicle compliance to tightening emission standards, and enables improvements in fuel efficiency, safety, reliability and overall vehicle performance. Other distributed control architecture has already been successfully implemented into various tactical and commercial aircrafts.

However, applications, such as a drive-by-wire system utilizing a distributed control system architecture, pose unique challenges related to system responsiveness, reliability and fault tolerance. Deployment of the technology requires real-time-responsiveness, and high levels of fault-tolerance.

The distributed system architecture of typical drive-by-wire systems includes a number of distributed electronic control units interconnected by a communication network. Information is exchanged among the control units using a Time Triggered Protocol (TTP/C) executed with the communications network. To impart fault-tolerance to the drive-by-wire functionality, redundancy is typically introduced at several levels. Nodes, comprising various critical electric/electronic devices, communicate with each other and with other nodes on a dual-redundant bus as shown in FIG. 1. Nodes include sensors, actuators, and micro-controllers, and are typically arranged in redundant pairs to impart a level of fault tolerance. Each node is designed to be a fail-silent unit (‘FSU’), i.e., it either operates correctly or is completely silent toward the communication bus. Two or more FSUs performing identical tasks form a fault-tolerant unit (‘FTU’). Each FTU operating in conjunction with the dual redundant communications bus increases fault-tolerance of the entire system. The system shown in FIG. 1 comprises an exemplary steer-by-wire system, which is a subset of a drive-by-wire system for a vehicle. The TTP/C communication bus forms the backbone of the system and connects three FTUs: steering wheel unit, steer-by-wire control unit and steering actuator unit. The steering wheel unit and the steer-by-wire control unit each consist of two replicated fail-silent nodes and each node of the two FTU units is connected to two TTP/C communication buses.

TTP/C comprises a known time-triggered communication protocol for critical distributed real-time control systems. Its intended application domains include automotive control systems, aircraft control systems, industrial and power plants, and, air-traffic control. A computer control system built around the TTP/C protocol consists of at least one computational cluster. Such a computational cluster comprises a set of self-contained computers (nodes), which communicate via a broadcast bus using the TTP/C protocol. An approximate global time base is established throughout the cluster by synchronizing the clocks located within the nodes. Each node is considered to be fail-silent, i.e., only crash failures and omission failures can occur. On the cluster level, node failures and communication failures may be masked by replicating the nodes and grouping them into Fault-Tolerant Units (FTUs). Message transmission is preferably replicated in both the space domain, by using two redundant busses, and the time domain, by sending the messages twice on each bus.

In this configuration, when one of the communication buses fails, the steer-by-wire subsystem continues to function as intended. However, in the event that both communication buses fail at a point, the three FTUs of the steer-by-wire subsystem fail to communicate with each other, and consequently cease to function as intended. In some cases, this may lead to compromised vehicle steering capability.

Therefore, there is need for a fault-tolerant distributed architecture system that is operable to provide an enhanced level of responsiveness, reliability, and fault tolerance.

### SUMMARY OF THE INVENTION

The present invention enhances reliability and fault-tolerance of a system comprising a distributed system architecture, such as a steer-by-wire system for a motor vehicle.

Providing a real-time fault-tolerant wireless networking architecture for the drive-by-wire functionality in automobiles improves system reliability. The wireless fault-tolerant architecture can provide backup capability, or complementary communications capability. This invention provides such a wireless architecture for next-generation vehicles. The novel drive-by-wire/wireless architecture uses multiple wireless sensors and short-range low-power radio transceivers associated with various micro-controllers in an electronic (i.e., drive-by-wire) vehicle. These sensors and radio transceivers allow the various micro-controllers to communicate critical vehicle control signals and drive commands, in the event of a physical breakdown of communications in the “wire” of the drive-by-wire system. This leads to improved levels of fault-tolerance to the drive-by-wire vehicle.

In order to achieve the object of this invention, a fault-tolerant architecture is offered, comprising a plurality of fault tolerant units, a wire-based communication bus over which said plurality of fault tolerant units communicate, and at least one radio transceiver associated with each of the plurality of fault tolerant units. The fault-tolerant units are operable to communicate therebetween using the radio transceivers when communication via the wire-based communication bus is compromised, such as when a single fault or multiple faults occur.

Another aspect of the invention includes each fault tolerant unit comprising a plurality of redundant devices operable to communicate therebetween. Each redundant device may be a sensor, an actuator, or a controller.

Another aspect of the invention includes a separate radio transceiver associated with each of the redundant devices.

Another aspect of the invention includes the wire-based communication bus being a dual redundant bus, operable to execute a time-triggered communications protocol.

Another aspect of the invention includes the fault tolerant units operable to communicate therebetween on the occurrence of a single fault, and on the occurrence of multiple faults.

Another aspect of the invention includes the fault tolerant units operable to establish an ad hoc network to communicate therebetween, using the radio transceivers. The ad hoc network may comprise a hierarchical network, or, alternatively, a mesh network.

A further aspect of the invention includes a diagnostic system operable to locate the fault.

Another aspect of the invention includes a plurality of radio transceivers associated with each of the plurality of fault tolerant units, wherein each radio transceiver executes a unique communications protocol.

Another aspect of the invention includes the fault tolerant architecture, including a plurality of fault tolerant units, wherein the fault-tolerant units are operable to diagnose a fault in the wire-based communication bus.

Another aspect of the invention comprises a control system having distributed architecture, comprising at least one radio transceiver associated with each of the fault tolerant units, which are operable to communicate therebetween using the radio transceivers. A wire-based communication bus over which the fault tolerant units communicate is included. The fault tolerant units communicate therebetween using the radio transceivers when a fault occurs in the wire-based communication bus, and identify a location of the fault occurring in the wire-based communication bus. The control system having distributed architecture preferably comprises a steer-by-wire system for a motor vehicle.

Another aspect of the invention comprises a fault tolerant control system having a distributed architecture comprising a plurality of fault tolerant units, and a wire-based communication bus over which the fault tolerant units communicate. Predetermined ones of the fault tolerant units have at least one radio transceiver associated therewith, and the radio transceivers are operable to communicate therebetween when a fault occurs in the wire-based communications bus. The predetermined ones of the fault tolerant units having at least one radio transceiver associated therewith can comprise two of the fault tolerant units, or possibly all of the fault tolerant units of the fault tolerant control system. A further aspect of the invention comprises the wire-based communications bus and at least one of the fault tolerant units having radio transceivers associated therewith.

Another aspect of the invention comprises a method for effecting communications in the control system having distributed architecture including fault tolerant units and a wire-based communication bus. The invention includes equipping predetermined ones of the fault tolerant units and the wireless communications bus with radio transceivers; and, communicating therebetween using the radio transceivers when a fault occurs in the wire-based communication bus.

These and other aspects of the invention will become apparent to those skilled in the art upon reading and understanding the following detailed description of the embodiments.

### BRIEF DESCRIPTION OF THE DRAWINGS

The invention may take physical form in certain parts and arrangement of parts, the preferred embodiment of which will be described in detail and illustrated in the accompanying drawings which form a part hereof, and wherein:

FIG. 1 is a schematic of a prior art system, in accordance with the present invention;

FIGS. 2-6 are schematic system diagrams, in accordance with the present invention; and,

FIGS. 7 and 8 are schematic diagrams, in accordance with the present invention.

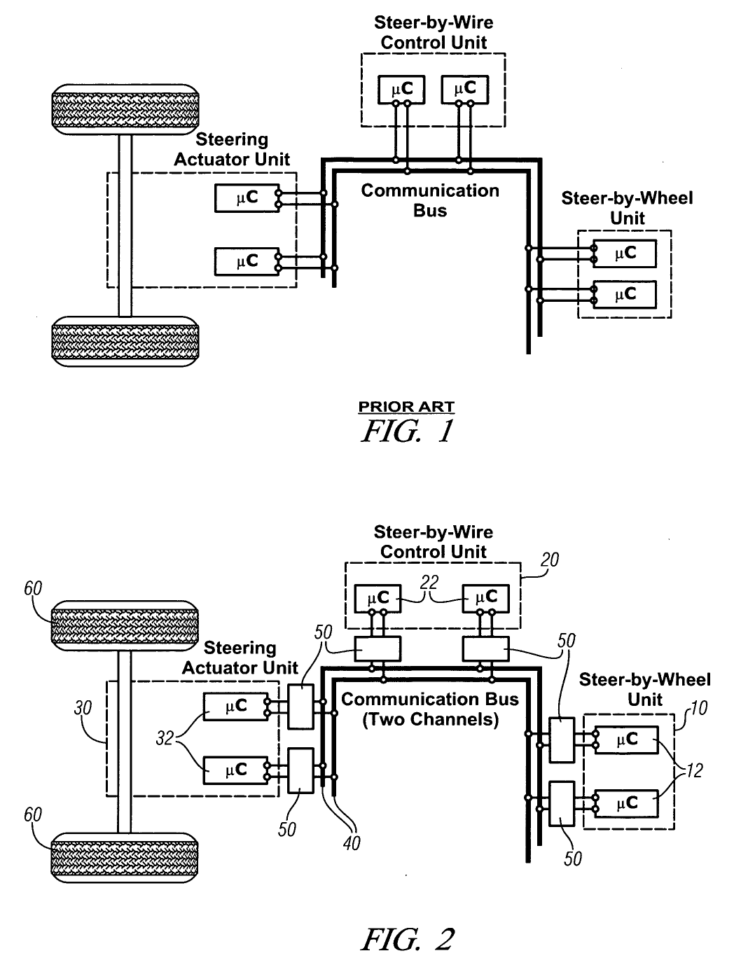

### DETAILED DESCRIPTION OF THE PREFERRED EMBODIMENT

Referring now to the drawings, wherein the showings are for the purpose of illustrating the invention only and not for the purpose of limiting the same, FIGS. 2-6 shows exemplary embodiments of a fault-tolerant distributed control architecture in accordance with the invention described herein. The exemplary system comprises a control system for a steer-by-wire control system executed for use on a motor vehicle.

Referring now to FIG. 2, a schematic system of a fault-tolerant distributed system architecture for a steer-by-wire control system which has been constructed in accordance with a first embodiment of the present invention is shown. The FTUs of the exemplary system comprise a steer-by-wire or steering wheel unit 10, a steer-by-wire control unit 20, and a steering actuator unit 30. The steering wheel FTU 10 is operable to determine operator input regarding vehicle direction, and preferably includes fail-silent nodes comprising dual redundant sensors and microcontrollers 12, each hard-wire connected to both channels 40 of a dual redundant communications bus. Radio transceivers 50, comprising short-range low power radio transceivers executing a specific communications protocol, are associated with each of the dual redundant microcontrollers 12. The steer-by-wire control unit FTU 20 preferably includes fail-silent nodes comprising dual redundant microcontrollers 22, each hard-wire connected to both channels 40 of the dual redundant communications bus. The dual redundant communications bus preferably achieves communications using a known time-triggered communication protocol (TTP/C). Individual radio transceivers 50, analogous to the aforementioned transceivers, are associated with each of the dual redundant microcontrollers 22. Steering actuator FTU 30 preferably includes fail-silent nodes comprising dual redundant microcontrollers 32, each hard-wire connected to both channels 40 of the dual redundant communications bus. Individual radio transceivers 50, analogous to all of the aforementioned transceivers, are associated with each of the dual redundant microcontrollers 32. The FTUs are operable to communicate therebetween using the radio transceivers 50 when communication via the wire-based communication bus is compromised, as described hereinafter.

Referring again to the fault tolerant system shown in FIG. 2, the wireless (radio) transceivers 50 provided in each the FTUs 10, 20, 30 are hard-wired to all the fail-silent nodes of the FTUs and communicate with them on a regular basis. However, the radio nodes do not communicate with other radio nodes unless activated by one or more of the individual FTUs 10, 20, 30. The radio nodes have the same characteristic functional properties as the other FSUs of the FTUs and once activated, they communicate with other radio nodes wirelessly over point-to-point links using the TTP/C protocol. In the event of multiple faults, the radio nodes may form an ad hoc, peer-to-peer network to relay information from one control unit of the drive-by-wire system to the other.

In operation, the following two functional scenarios explain the functioning of the invention, with reference again to the exemplary steer-by-wire subsystem. The general concept is readily applied to other subsystems having a need for high fault tolerance.

In the event of a single point fault of the communication bus 40 between the steer-by-wire control unit 20 and the steering wheel unit 10, the units 10 and 20 no longer communicate with each other. Nor can the steering wheel unit 10 communicate with the steering actuator unit 30. In such circumstances, the microcontrollers 22 of the steer-by-wire control unit 20 and the microcontrollers 12 of the steering wheel unit 10 activate their respective radio transceivers 50 after determining that communications have been interrupted. The two units 10, 20 are able to exchange information and control signals wirelessly using their respective radio transceivers 50. In addition, the steering wheel unit 10 may forward information and control signals for the steering actuator unit 30 to the steer-by-wire control unit 20, wirelessly. These signals are communicated to the steering actuator unit 30 via the communication bus 40. Communicated signals can comprise signals for controlling the steer-by-wire actuator unit 30 with the steering wheel control unit 20, based upon input from the steering wheel unit 10. Communicated signals can comprise signals useable to diagnose presence and location of the single fault.

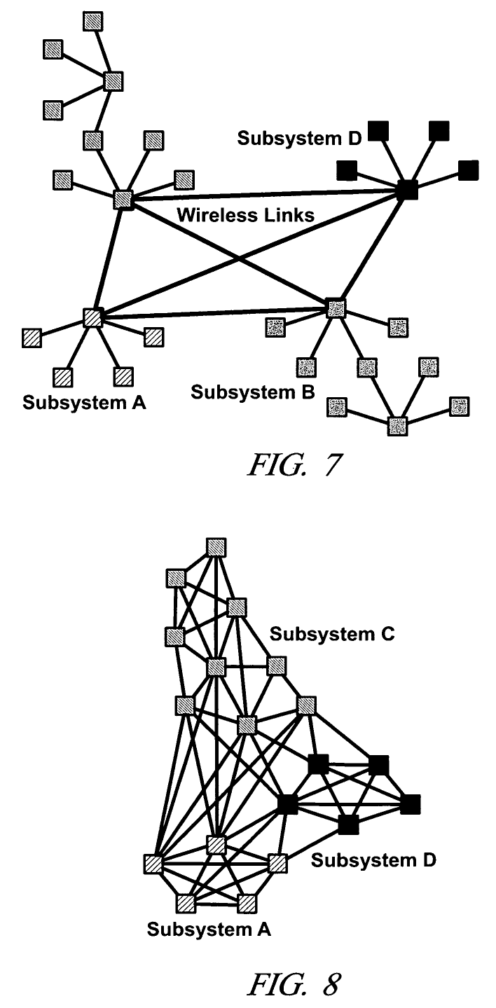

In the event of multiple faults along the communication bus 40, several FTUs 10, 20, 30 can activate their radio transceivers 50 simultaneously to establish a wireless ad-hoc network to exchange information and control signals. The ad-hoc networking structure can be one of several variations. Referring now to FIGS. 7 and 8, the wireless ad-hoc network may alternately be a hierarchical design with one control node as a master unit, and other control nodes becoming slave units (see FIG. 7), or a mesh-like design with all nodes interacting with all others based on their respective identifiers (see FIG. 8). In the hierarchical design, shown representatively in FIG. 7, each block represents a node of the system with associated radio transceiver, and each line between blocks represents a wireless connection. The nodes are arranged in subsystems, e.g. subsystems A, B, C, and D, each which preferably corresponds to an FTU of a system when applied to the embodiments described herein. One of the related radio transceivers of the exemplary subsystem, or FTU, is chosen as a leader to communicate all information and control signals between the FTU and other FTUs. The leader of the FTU forwards select information and control signals to corresponding leaders of other FTUs, which transmit such information to subordinate nodes. At the highest level, the leader radio nodes may communicate in a round-robin fashion or may establish a mesh-like design. As compared to the mesh-like design shown representatively in FIG. 8, the hierarchical approach allows minimal radio interference in the system, and is relatively easy to design into a system. However, undesirable latencies may be introduced into the system, and the system may not provide the best performance with the TTP/C. Alternatively, in the mesh-like design, shown representatively with reference to FIG. 8, each radio node directly communicates with the other radio nodes in real-time. With the choice of appropriate wireless technologies that are resistant to interference and multipath (i.e. known systems, like wide bandwidth and spreading techniques such as UWB and CDMA), the desired reliability of “Drive-by-Wireless” architecture may be achieved.

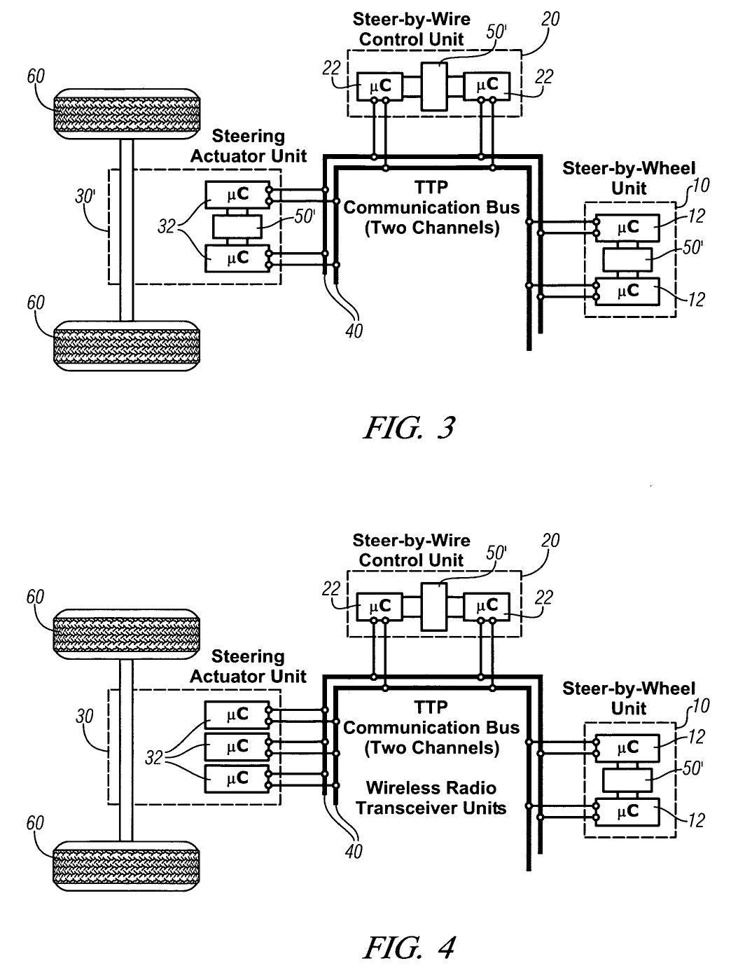

Referring now to FIGS. 3 through 6, various alternate embodiments of the invention are described, with common elements designated with similar numbers. Elements designated as numbers with prime (′) or double prime (″) have similar functionality and features, and may have additional features or functionalities. The alternate embodiments afford system design flexibility driven at least in part by determinations of system reliability for applications of the invention.

Referring now to FIG. 3, a first alternate embodiment of the invention is presented. In this embodiment, the FTUs of the exemplary system comprise the steering wheel unit 10, the steer-by-wire control unit 20, and the steering actuator unit 30. The steering wheel FTU 10 preferably includes fail-silent nodes comprising dual redundant microcontrollers 12, each hard-wire connected to both channels 40 of the dual redundant communications bus. A single radio transceiver 50′ is associated with the dual redundant microcontrollers 12, and communicates with both microcontrollers 12. The steer-by-wire control unit FTU 20 preferably includes fail-silent nodes comprising dual redundant microcontrollers 22, each hard-wire connected to both channels 40 of the dual redundant communications bus. An analogous single radio transceiver 50′ is associated with both of the dual redundant microcontrollers 22. Steering actuator FTU 30 preferably includes fail-silent nodes comprising dual redundant microcontrollers 32, each hard-wire connected to both channels 40 of the dual redundant communications bus. Another analogous single radio transceiver 50′ is associated with both of the dual redundant microcontrollers 32. The dual redundant communications bus preferably achieves communications using known time-triggered communication protocol (TTP/C). The FTUs are operable to communicate therebetween using the analogous radio transceivers 50′ when communication via the wire-based communication bus is compromised, as described hereinabove.

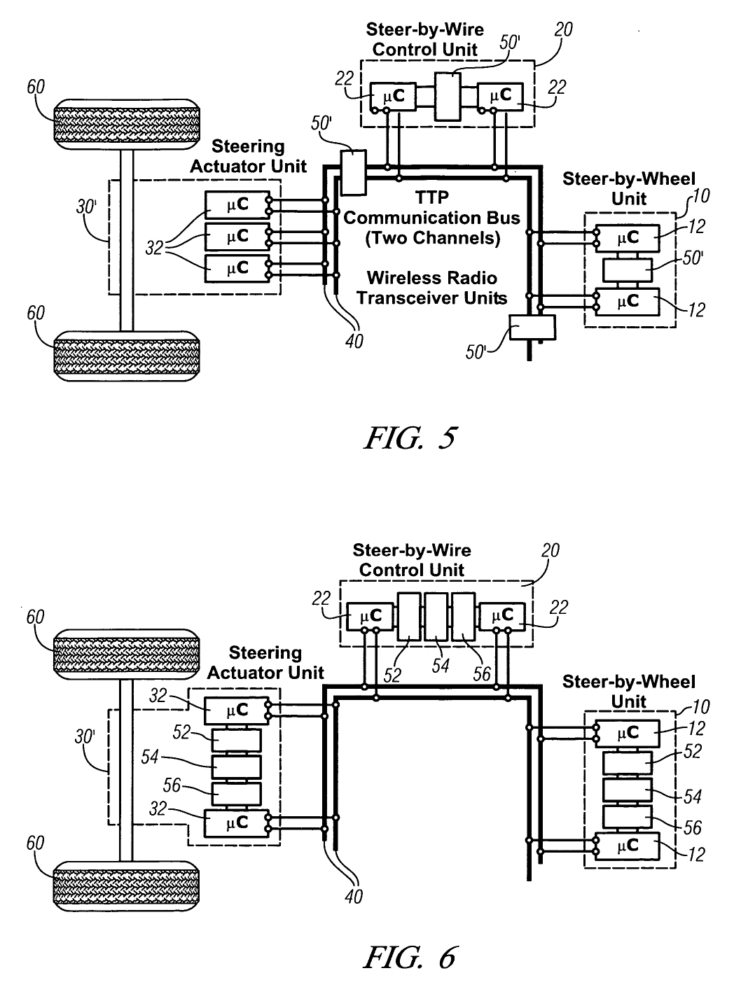

Referring now to FIGS. 4 and 5, alternative embodiments of the invention are presented, referred to as hybrid systems. Each hybrid fault tolerant control system typically comprises a distributed architecture having a plurality of fault tolerant units and the wire-based communication bus over which said fault tolerant units communicate. Predetermined ones of the fault tolerant units have at least one radio transceiver associated therewith, typically not all of the fault tolerant units of the control system.

Referring again to the embodiment shown with reference to FIG. 4, the FTUs of the exemplary system comprise the steering wheel unit 10, the steer-by-wire control unit 20, and the steering actuator unit 30. The steering wheel FTU 10 preferably includes fail-silent nodes comprising dual redundant microcontrollers 12, each hard-wire connected to both channels 40 of the dual redundant communications bus. A single radio transceiver 50′ is associated with the dual redundant microcontrollers 12, and communicates with both. The steer-by-wire control unit FTU 20 preferably includes fail-silent nodes comprising dual redundant microcontrollers 22, each hard-wire connected to both channels 40 of the dual redundant communications bus. Another analogous single radio transceiver 50′ is associated with both of the dual redundant microcontrollers 22. Steering actuator FTU 30 preferably includes fail-silent nodes comprising triple-redundant microcontrollers 32, each hard-wire connected to both channels 40 of the dual redundant communications bus. The dual redundant communications bus preferably achieves communications using known time-triggered communication protocol (TTP/C). The steer-by-wire control unit 20 and the steering wheel unit 10 are operable to communicate therebetween using the analogous radio transceivers 50′ when a fault occurs in communication over the wire-based communication bus 40 between steer-by-wire control unit FTU 20 and steering wheel FTU 10, as described hereinabove.

Referring now to FIG. 5, another alternate embodiment of the hybrid system is presented. In this embodiment, the FTUs of the exemplary system comprise the steer-by-wire or steering wheel unit 10, the steer-by-wire control unit 20, and the steering actuator unit 30. The steering wheel FTU 10 preferably includes fail-silent nodes comprising dual redundant microcontrollers 12, each hard-wire connected to both channels 40 of the dual redundant communications bus. Single radio transceiver 50′ is associated with the dual redundant microcontrollers 12, and communicates with both. The steer-by-wire control unit FTU 20 preferably includes fail-silent nodes comprising dual redundant microcontrollers 22, each hard-wire connected to both channels 40 of the dual redundant communications bus. An analogous single radio transceiver 50′ is associated with both of the dual redundant microcontrollers 22. Steering actuator FTU 30 preferably includes fail-silent nodes comprising triple-redundant microcontrollers 32, each hard-wire connected to both channels 40 of the dual redundant communications bus. The dual redundant communications bus includes a plurality of analogous radio transceivers 50′ operable to effect wireless communications through the dual redundant communication bus 40, again using known time-triggered communication protocol (TTP/C). The steer-by-wire control unit 20 and the steering wheel unit 10 are operable to communicate therebetween using the analogous radio transceivers 50′ when communication via the wire-based communication bus is compromised, as described hereinabove.

Referring now to FIG. 6, another alternate embodiment of the invention is presented. In this embodiment, the FTUs of the exemplary system comprise the steering wheel unit 10, the steer-by-wire control unit 20, and the steering actuator unit 30. The steering wheel FTU 10 preferably includes fail-silent nodes comprising dual redundant microcontrollers 12, each hard-wire connected to both channels 40 of the dual redundant communications bus. A plurality of radio transceivers 52, 54, 56 is associated with the dual redundant microcontrollers 12. Each of the radio transceivers 52, 54, 56 executes a unique communications protocol, and each is operable to communicate with other analogous radio transceivers executing the same protocol which are associated with the steer-by-wire control unit 20, and the steering actuator unit 30. The radio transceivers 52, 54, 56 can represent different air interface protocols or physical layers, e.g. UWB, WiFi, DSRC. Furthermore, although the radio transceivers 52, 54, 56 are depicted as individual devices, they may alternatively be integrated into a common chip set in a single device for ease of packaging and assembly.

Each of the radio transceivers 52, 54, 56 of FTU 10 communicates with both of the dual redundant microcontrollers 12. The steer-by-wire control unit FTU 20 preferably includes fail-silent nodes comprising dual redundant microcontrollers 22, each hard-wire connected to both channels 40 of the dual redundant communications bus. A second, analogous plurality of radio transceivers 52, 54, 56 is associated with both of the dual redundant microcontrollers 22. Steering actuator FTU 30 preferably includes fail-silent nodes comprising dual redundant microcontrollers 32, each hard-wire connected to both channels 40 of the dual redundant communications bus. A third, analogous plurality of radio transceivers 52, 54, 56 is associated with both of the dual redundant microcontrollers 32. The dual redundant communications bus in this embodiment achieves communications using a known time-triggered communication protocol (TTP/C). Alternatively, other communication protocols may be effectively implemented. The FTUs are operable to communicate therebetween using the analogous radio transceivers 52, 54, 56 when communications via the wire-based communication bus is compromised, as described hereinabove.

Furthermore, in each of the embodiments of the exemplary system, the FTUs preferably contain algorithms and control systems which execute diagnostic systems operable to identify and locate a fault in the system.

The invention has been described with specific reference to the preferred embodiments and modifications thereto. Further modifications and alterations may occur to others upon reading and understanding the specification. It is intended to include all such modifications and alterations insofar as they come within the scope of the invention.

Having thus described the invention, it is claimed:

1. Fault tolerant architecture, comprising:
a plurality of fault tolerant units;
a wire-based communication bus over which said fault tolerant units communicate;
at least one radio transceiver associated with each of the fault tolerant units; and,
the fault-tolerant units operable to communicate therebetween using the radio transceivers when a fault occurs in the wire-based communication bus.

2. The apparatus of claim 1, wherein each fault tolerant unit comprises a plurality of redundant devices operable to communicate therebetween.

3. The apparatus of claim 2, wherein each redundant device comprises a sensor.

4. The apparatus of claim 2, wherein each redundant device comprises an actuator.

5. The apparatus of claim 2, wherein each redundant device comprises a controller.

6. The apparatus of claim 2, wherein a separate radio transceiver is associated with each of the redundant devices.

7. The apparatus of claim 1, wherein the wire-based communication bus comprises a dual redundant bus.

8. The apparatus of claim 7, wherein the wire-based communication bus further comprises the dual redundant bus operable to execute a time-triggered communications protocol.

9. The apparatus of claim 1, wherein the fault tolerant units operable to communicate therebetween using the radio transceivers when a fault occurs in the wire-based communication bus comprises the fault tolerant units operable to communicate therebetween on the occurrence of a single fault.

10. The apparatus of claim 1, wherein the fault tolerant units operable to communicate therebetween using the radio transceivers when a fault occurs in the wire-based communication bus comprises the fault tolerant units operable to communicate therebetween on the occurrence of multiple faults.

11. The apparatus of claim 1, wherein the fault tolerant units operable to communicate therebetween using the radio transceivers further comprises the fault tolerant units operable to establish an ad hoc network to communicate therebetween.

12. The apparatus of claim 11, wherein the ad hoc network to communicate therebetween comprises a hierarchical network.

13. The apparatus of claim 11, wherein the ad hoc network to communicate therebetween comprises a mesh network.

14. The apparatus of claim 1, further comprising a diagnostic system operable to identify a location of the fault occurring in the wire-based communication bus.

15. The apparatus of claim 1, comprising a plurality of radio transceivers associated with each of the fault tolerant units.

16. The apparatus of claim 15, wherein each of the radio transceivers associated with one of the fault tolerant units is operable to execute a unique communications protocol.

17. Control system having distributed architecture, comprising:
a plurality of fault tolerant units;
at least one radio transceiver associated with each of the fault tolerant units; and,
the fault-tolerant units operable to communicate therebetween using the radio transceivers.

18. The control system of claim 17, further comprising a wire-based communication bus over which the fault tolerant units communicate.

19. The control system of claim 18, further comprising the fault tolerant units operable to communicate therebetween using the radio transceivers when a fault occurs in the wire-based communication bus.

20. The control system of claim 19, further comprising the fault-tolerant units operable to identify a location of the fault occurring in the wire-based communication bus.

21. The control system of claim 20, wherein the control system having distributed architecture comprises a steer-by-wire system.

22. The control system of claim 21, wherein the control system further comprises a steer-by-wire system for a motor vehicle.

23. Fault tolerant control system, comprising:
a distributed architecture comprising a plurality of fault tolerant units;
a wire-based communication bus over which said fault tolerant units communicate;
predetermined ones of the fault tolerant units having at least one radio transceiver associated therewith; and,
the radio transceivers operable to communicate therebetween when a fault occurs in the wire-based communications bus.

24. The fault tolerant control system of claim 23, wherein the predetermined ones of the fault tolerant units having at least one radio transceiver associated therewith comprise at least two of the fault tolerant units.

25. The fault tolerant control system of claim 24, wherein the predetermined ones of the fault tolerant units having at least one radio transceiver associated therewith comprise all of the fault tolerant units of the fault tolerant control system.

26. The fault tolerant control system of claim 23, further comprising the wire-based communications bus having at least one radio transceiver associated therewith.

27. The fault tolerant architecture of claim 26, wherein the predetermined ones of the fault tolerant units having at least one respective radio transceiver associated therewith comprises a single fault tolerant unit.

28. Method for effecting communications in a control system having a distributed architecture comprising a plurality of fault tolerant units having a wire-based communication bus over which said plurality of fault tolerant units communicate, comprising:
equipping predetermined ones of the fault tolerant units and the wireless communications bus with radio transceivers; and,
communicating therebetween using the radio transceivers when a fault occurs in the wire-based communication bus.
